(19) United States
(12) Patent Application Publication
(10) Pub. No.: US 2009/0059976 A1
(43) Pub. Date: Mar. 5, 2009

(54) LASER MODULE AND METHOD FOR ADJUSTING OPTICAL AXIS OF THE SAME

(75) Inventor: Kazuhiro SHIBATANI, Sakai-shi (JP)

Correspondence Address: SIDLEY AUSTIN LLP, 717 NORTH HARWOOD, SUITE 3400, DALLAS, TX, 75201, US

(73) Assignee: Konica Minolta Opto, Inc., Tokyo (JP)

(21) Appl. No.: 12/049,568

(22) Filed: Mar. 17, 2008

(30) Foreign Application Priority Data
Mar. 23, 2007 (JP) 2007-076087

(51) Int. Cl. H01S 3/10

(52) U.S. Cl. 372/29.01

(57) ABSTRACT

A laser module capable of easy optical axis adjustment between the very small waveguide in a short period of time, and a method for adjusting an optical axis thereof. The laser module includes a laser device LD; an optical waveguide device SHG equipped with a waveguide; lenses L1 and L2 for converging light from the laser device LD and leading it into the waveguide o; and an actuator for positioning the focusing spot formed by the lenses L1 and L2 in a 3D direction. If the intensity of the emerging light coming from the waveguide is less than or equal to a predetermined reference value, the focusing spot is defocused. Then, the position of the focusing spot is adjusted in a plane perpendicular to the optical axis. Then, the focusing spot is adjusted to be in focus.

This application is based on Japanese Patent Application No. 2007-076087 filed on Mar. 23, 2007, in Japanese Patent Office, the entire content of which is hereby incorporated by reference.

### TECHNICAL FIELD

The present invention relates to a laser module for facilitating optical axis adjustment for alignment of a laser device with an optical waveguide device, and a method for adjusting an optical axis of the laser module.

### BACKGROUND

In an optical module using an optical waveguide device, a light source is generally required to be optically coupled with the channel optical waveguide having predetermined functions such as optical waveguide function, light modulation function, wavelength filtering function and branching/multiplexing function.

The following Unexamined Japanese Patent Application Publication No. 2003-338795 discloses a method wherein, in an optical communication module, a condenser lens is arranged between a laser light source and incidence plane of the optical fiber, and this condenser lens is wobbled by an actuator in the X or Y direction at a predetermined period and amplitude, whereby an optical axis error signal is obtained.

However, light input/output end face of the optical waveguide device generally has an area of about 1 mm×1 mm, and the cross sectional dimension of the channel waveguide requiring optical coupling is about several microns square. This value is very small as compared with the area of the entire device.

Thus, when raster scanning is applied to the light input/output end face of the optical waveguide device to find out the position of the channel waveguide, a very long scanning time is required since the scanning pitch is as small as the order of several microns.

### SUMMARY

The object of the present invention is to provide a laser module capable of easy optical axis adjustment for alignment of a very small waveguide with a laser source in a short time, and a method for adjusting an optical axis of the laser module.

In view of forgoing, one embodiment according to one aspect of the present invention is a laser module, comprising:

a laser device;

an optical waveguide device having a waveguide;

a light converging optical system for converging a light beam from the laser device to form a focusing spot at which a diameter of the light beam is the smallest, and leading the converged light beam into the waveguide of the optical waveguide device; and

an actuator mechanism for three dimensionally positioning the focusing spot.

According to another aspect of the present invention, another embodiment is a method for adjusting an optical axis of a laser module having a laser device; an optical waveguide device having a waveguide; a light converging optical system for converging a light beam from the laser device to form a focusing spot at which a diameter of the light beam is the smallest, and leading the converged light beam into the waveguide of the optical waveguide device; and an actuator mechanism for three dimensionally positioning the focusing spot by driving the light converging optical system, the method comprising the steps of:

measuring intensity of an emerging light beam from the waveguide by a photosensor provided on a light emitting side of the optical waveguide device;

adjusting, when the intensity of the emerging light beam is greater than a predetermined reference value, a position of the focusing spot by using the actuator mechanism in a first direction perpendicular to an optical axis direction and in a second direction perpendicular to the optical axis direction and the first direction so that the intensity of the emerging light beam is at a peak value thereof; and

focusing, after the step of adjusting, the converging optical system by adjusting the position of the focusing spot by using the actuator mechanism in an optical axis direction so that the intensity of the emerging light beam is at a peak value thereof after the step of adjusting.

According to another aspect of the present invention, another embodiment is a method for adjusting an optical axis of a laser module having a laser device; an optical waveguide device having a waveguide; a light converging optical system for converging a light beam from the laser device to form a focusing spot at which a diameter of the light beam is the smallest, and leading the converged light beam into the waveguide of the optical waveguide device; and an actuator mechanism for three dimensionally positioning the focusing spot by driving the light converging optical system, the method comprising the steps of:

measuring intensity of an emerging light beam from the waveguide by a photosensor provided on a light emitting side of the optical waveguide device;

defocusing, when the intensity of the emerging light beam is less than or equal to a predetermined reference value, the converging optical system by adjusting a position of the focusing spot in the optical axis direction by using the actuator mechanism;

adjusting, after the step of defocusing, the position of the focusing spot by using the actuator mechanism in a first direction perpendicular to an optical axis direction and in a second direction perpendicular to the optical axis direction and the first direction so that the intensity of the emerging light beam is at a peak value thereof; and

focusing, after the step of adjusting, the converging optical system by adjusting the position of the focusing spot by using the actuator mechanism in the optical axis direction so that the intensity of the emerging light beam is at a peak value thereof.

### BRIEF DESCRIPTION OF THE DRAWINGS

FIG. 1 is a schematic diagram representing an example of a laser module according to an embodiment of the present invention;

FIG. 2 is a schematic diagram representing another example of a laser module according to an embodiment of the present invention;

FIG. 3 is a schematic diagram representing still another example of a laser module according to an embodiment of the present invention;

FIG. 4(a) is a schematic diagram representing an example of a three-axis control actuator;

FIG. 4(b) is a schematic diagram representing an example of a two-axis control actuator;

FIGS. 5(a), 5(b) and 5c are charts showing changes in power entering the waveguide with respect to a position of a focusing spot on the x-, y- and z-axis;

FIGS. 6(a) and 6(b) show the configuration of a laser light spot in the incident end face (x-y plane) of an optical waveguide device SHG;

FIG. 7(a), 7(b) and 7(c) are explanatory diagrams showing an example of a method for adjusting an optical axis of a laser module in an embodiment of the present invention;

FIGS. 8(a), 8(b), 8(c) and 8(d) are explanatory diagrams showing another example of the method for adjusting an optical axis of a laser module in an embodiment of the present invention;

FIG. 9(a), 9(b), 9(c), 9(d), 9(e) and 9(f) are explanatory diagrams showing still another example of the method for adjusting an optical axis of a laser module in an embodiment of the present invention; and

FIG. 10 is a chart showing the power distribution in the state of focused and defocused focusing spot.

### DETAILED DESCRIPTION OF THE PREFERRED EMBODIMENT

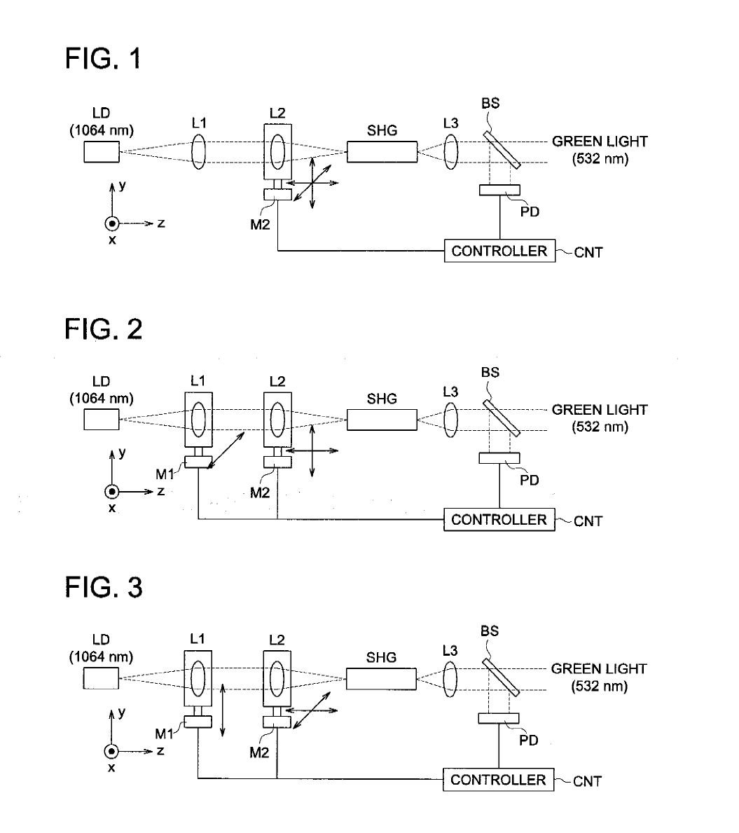

FIG. 1 is a schematic diagram representing an example of a laser module according to an embodiment of the present invention. In this case, an SHG (second harmonic generation) device is shown as an example of the optical waveguide device. The present invention is applicable to various forms of optical waveguide devices provided with a waveguide having a light modulation function, optical waveguide function and wavelength filtering function in addition to the harmonic generation function.

The laser module includes a laser device LD, a first lens unit such as lens L1, a second lens unit such as lens L2, optical waveguide device SHG and lens L3, as well as an actuator M2 for positioning the lens L2. Here, for ease of explanation, assume that z axis represents the optical axis direction (rightward on the sheet), y axis indicates the first direction perpendicular to the optical axis direction, e.g., vertical direction (upward on the sheet), and y axis shows the second direction perpendicular to the optical axis direction and the first direction, e.g., a horizontal direction (frontward on the sheet). The first lens unit and the second lens unit each may be a single lens.

The laser device LD includes a semiconductor laser and solid laser, and is fixed on the module enclosure (not illustrated).

The lens L1 converts the light diverging from the laser device LD into an approximately parallel light beam. The lens L2 converges the parallel light beam from the lens L1 to form a focusing spot where the diameter of the light beam is the smallest and a light spot on the incident end face of the optical waveguide device SHG. These lenses L1 and L2 serve as a light converging optical system that converges the light from the laser device LD and leads it into the optical waveguide device SHG. The light converging optical system can include various forms of optical devices such as other lenses and apertures, in addition to the lenses L1 and L2.

The lens L3 converges the light emitted from the waveguide of the optical waveguide device SHG and outputs it to the next stage.

The optical waveguide device SHG has a waveguide mounted on the top surface of the substrate. The substrate is made of a non-linear material such as a lithium niobate crystal. Generally, it is formed into a flat panel configuration having a rectangular cross section or prismatic configuration. The incident end face of the optical waveguide device SHG has cross sectional dimensions of about 1 mm×1 mm, for example.

The waveguide of the optical waveguide device SHG generally has a cross section of about several microns square. It forms a constant cross sectional shape from the incident end face to the emerging end face. It interacts with the light going through the waveguide and generates light having half the wavelength. For example, when the infrared ray having a wavelength of 1064 nm has entered the waveguide, it is changed into green light having a wavelength of 532 nm. To increase the wavelength conversion efficiency, the waveguide generally has a periodic inverted domain structure that provides phase alignment between the infrared ray and green light.

The laser module is further equipped with a beam splitter BS that reflects part of the light emitted from the lens L3 and allows the rest of the light to pass by, a photodetector such as a monitoring photodiode PD for receiving light reflected from the beam splitter BS, and a controller CNT for controlling the actuators based on the output of the photodetector, on the output side of the laser module. The photodiode PD may detect only the fundamental wave (e.g., infrared ray) having passed through the optical waveguide device SHG, or only the second harmonics (e.g., green light) generated from the optical waveguide device SHG. Alternatively, it may detect both the fundamental wave and the second harmonics.

In the laser module of FIG. 1, the actuator M2 has a function of controlling the position of the lens L2 in the 3D directions, namely, in the x-, y- and z-axis directions. This arrangement positions the focusing spot formed by the light converging optical system including the lenses L1 and L2 in the 3D directions, namely, in the x-, y- and z-axis directions.

FIG. 2 is a schematic diagram representing another example of a laser module as according to an embodiment of the present invention. This laser module includes the same device structure as that of the laser module of FIG. 1, except that an actuator M1 for positioning the lens L1 is additionally mounted.

The laser device LD, lens L1, lens L2, optical waveguide device SHG, lens L3, beam splitter BS and photodiode PD have the same functions as those of FIG. 1.

In the laser module of FIG. 2, the actuator M1 has a function of controlling the position of the lens L1 in the x-axis direction. The actuator M2 has a function of controlling the position of the lens L2 in the y- and z-axis directions. This arrangement positions the focusing spot formed by the light converging optical system including the lenses L1 and L2 in the 3D directions, namely, in the x-, y- and z-axis directions.

FIG. 3 is a schematic diagram representing still another example of a laser module according to an embodiment of the present invention. This laser module includes the same device structure as that of the laser module of FIG. 1, except that an actuator M1 for positioning the lens L1 is additionally mounted.

The laser device LD, lens L1, lens L2, optical waveguide device SHG, lens L3, beam splitter BS and photodiode PD have the same functions as those of FIG. 1.

In the laser module of FIG. 3, the actuator M1 has a function of controlling the position of the lens L1 in the y-axis direction. The actuator M2 has a function of controlling the position of the lens L2 in the x- and z-axis directions. This arrangement positions the focusing spot converged by the light converging optical system including the lenses L1 and L2 in the 3D directions, namely, in the x-, y- and z-axis directions.

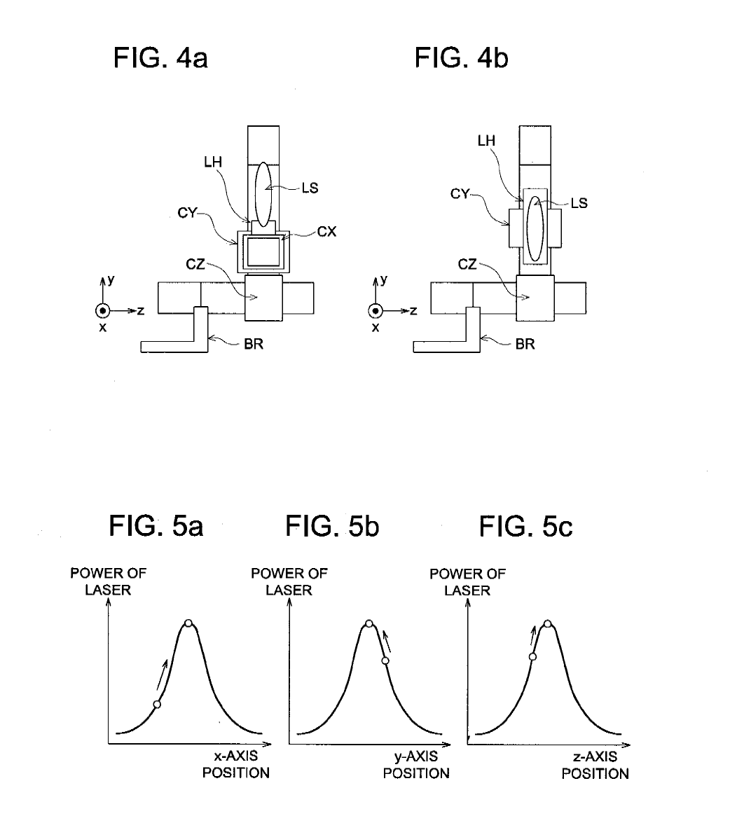

FIG. 4a is a schematic diagram representing an example of a three-axis control actuator. FIG. 4b is a schematic diagram representing an example of a two-axis control actuator. The three-axis control actuator of FIG. 4a has an x-axis traveling member CX, y-axis traveling member CY and z-axis traveling member CZ, each being made up of a Smooth Impact Drive Mechanism (SIDM) disclosed, for example, in the Unexamined Japanese Patent Application Publication No. 2002-95272.

The SIDM includes a traveling member having a certain mass, a rod for holding this traveling member by friction, and a piezoelectric device connecting between the rod and fixing member (base). The operation is performed in such a way that the rod is displaced in the longitudinal direction by the extension and contraction of the piezoelectric device, and whether the traveling member is kept standstill by inertia or follows the movement of the rod is selected by differentiating the extension speed and the contraction speed of the rod by a saw-toothed drive wave form This procedure allows cumulative displacement of the traveling member.

The z-axis traveling member CZ is held by the rod extending in the z-axis direction. This z-axis rod is supported by the bracket BR through the piezoelectric device for the z-axis drive. This bracket BR is mounted on the module enclosure (not illustrated).

The y-axis traveling member CY is held by the rod extending in the y-axis direction. This y-axis rod is mounted on the z-axis traveling member CZ through the piezoelectric device for the y-axis drive.

The x-axis traveling member CX is held by the rod extending in the x-axis direction. This x-axis rod is mounted on the y-axis traveling member CY through the piezoelectric device for the x-axis drive. A lens holder LH for holding a lens LS is mounted on the x-axis traveling member CX.

The two-axis control actuator of FIG. 4b is the same as the three-axis control actuator of FIG. 4a, except that the x-axis control system is removed. To put it another way, the lens holder LH for holding the lens LS is mounted on the y-axis traveling member CY.

In the conventional laser module, normally, the focusing spot formed by the light converging optical system is positioned only in the 2D directions, namely, in the x-axis and y-axis directions. The z-axis positioning function (in the optical axis direction) is not provided. Accordingly, when the focusing spot formed by the light converging optical system is accidentally nearly focused, and the diameter of the light spot on the incident end face of the optical waveguide device SHG is very small, the positioning between the light spot and waveguide is very difficult in the conventional laser module.

In the laser module of the present invention, the focusing spot of the light converging optical system can be positioned not only in the x-axis and y-axis directions but also in the z-axis direction (optical axis direction). For example, when the diameter of the light spot on the incident end face is very small, the focusing spot formed by light converging optical system is defocused temporarily by adjustment in the optical axis direction (z-axis direction) so that the diameter of the light spot on the incident end face becomes relatively large. The in-plane alignment (alignment in x-axis and y-axis directions) perpendicular to the optical axis direction is performed under this condition, whereby the positioning between the light spot and waveguide is much facilitated. After alignment, focusing control in the optical axis direction (z-axis direction) is performed. This procedure ensures easy 3D positioning of the focusing spot in a short time period.

Especially in the harmonic generation device, to improve the wavelength conversion efficiency, the power density of the laser beam entering the waveguide is preferably maximized. In the laser module of the present invention, the positioning in the optical axis direction can be performed, and hence accurate focusing of the focusing spot can be realized. This arrangement provides a considerable improvement of the wavelength conversion efficiency.

Further, 3D alignment of the light converging optical system is possible. This facilitates the component mounting accuracy at the time of assembling the laser module, and ensures simplification of the assembly apparatus and reduction in assembling time, with the result that the cost of manufacturing the laser module is cut down.

FIGS. 5a, 5b and 5c are charts showing changes in power entering the waveguide with respect to the position of the focusing spot on the x-, y- and z-axis. The power change in the in-plane area perpendicular to the light axis, namely, the power change with respect to x and y axes corresponds to the profile of the laser light spot, and typically exhibits the Gaussian distribution containing a single peak. Further, the power change with respect to z axis corresponds to the shape of the beam waist in the optical axis direction, and typically exhibits the Gaussian distribution containing a single peak.

This suggests that 3D peak positioning is possible by adjusting the traveling members to attain the peak of the laser power with respect to x, y and z axes. In the area wherein the laser power is not less than a predetermined reference value, peak positioning is achieved by fine alignment control (e.g., wobbling mode).

The following describes the x-axis and y-axis automatic alignment control. When the lens position is changed by the x-axis actuator and y-axis actuator, there is a corresponding change in the state of coupling between the waveguide and laser beam, hence there is a change in the power of green light emitted from the optical waveguide device SHG. The green light power is detected by the photodiode PD, and the signal thereof is processed by the low-pass filter (LPF) through the current/voltage conversion circuit. After that, the signal is inputted into a microcomputer through an analog-to-digital converter. Based on the detected value of the green light power, the controller CNT determines the traveling distance of the x-axis actuator and y-axis actuator, and provides drive control of the actuator of each axis. The drive signal of the actuator of each axis is generated by the PWM (Pulse Width Modulation) for each axis, and is inputted into the piezoelectric device of each axis through a power amplifier.

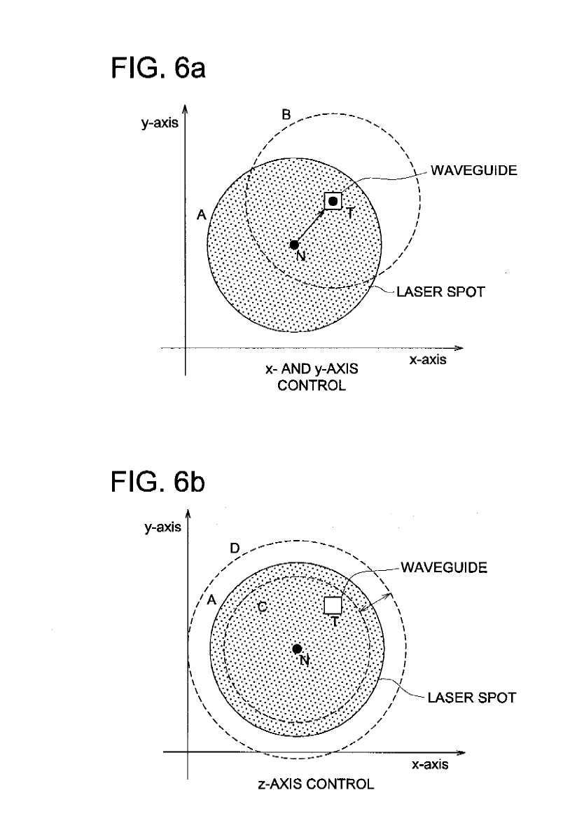

FIGS. 6a and 6b show the configuration of the laser light spot in the incident end face (x and y planes) of the optical waveguide device SHG. When the laser device LD generates the beam of the basic mode having a Gaussian distribution, the diameter of the laser light spot is determined by the status of focusing. To be more specific, when the focusing spot is focused by z-axis alignment, the diameter of the laser light spot is minimized. When the focusing spot is defocused, the diameter of the laser light spot is increased.

The peak power of the laser light spot is located at the center of the laser light spot, without depending on the state of focusing, namely, the diameter of the laser light spot. To put it another way, the exact alignment between the spot center (peak position) and the waveguide of the optical waveguide device SHG is realized by fine alignment control of the x and y axes, without depending on the state of focusing of the focusing spot.

Assume that the initial diameter of the light spot is A. When the focusing spot has been subjected to a movement in the direction toward focusing in by adjusting the z-axis, the diameter of the light spot is reduced, as indicated by C of FIG. 6b. When the focusing spot has been subjected to a movement in the direction toward defocusing by adjusting the z-axis, the diameter of the light spot is increased, as indicated by D of FIG. 6b. In these cases, the moving direction, of the focusing spot, where the laser power increases depends on where the position T indicating the waveguide center of the optical waveguide device SHG is positioned. To put it another way, the laser power may increase when the diameter is decreased to C, or may increase when the diameter is increased to D.

This shows that the peak within the x and y planes should be positioned first by the x-axis control and y-axis control, and the peak in the z-axis direction should then be positioned by the z-axis control.

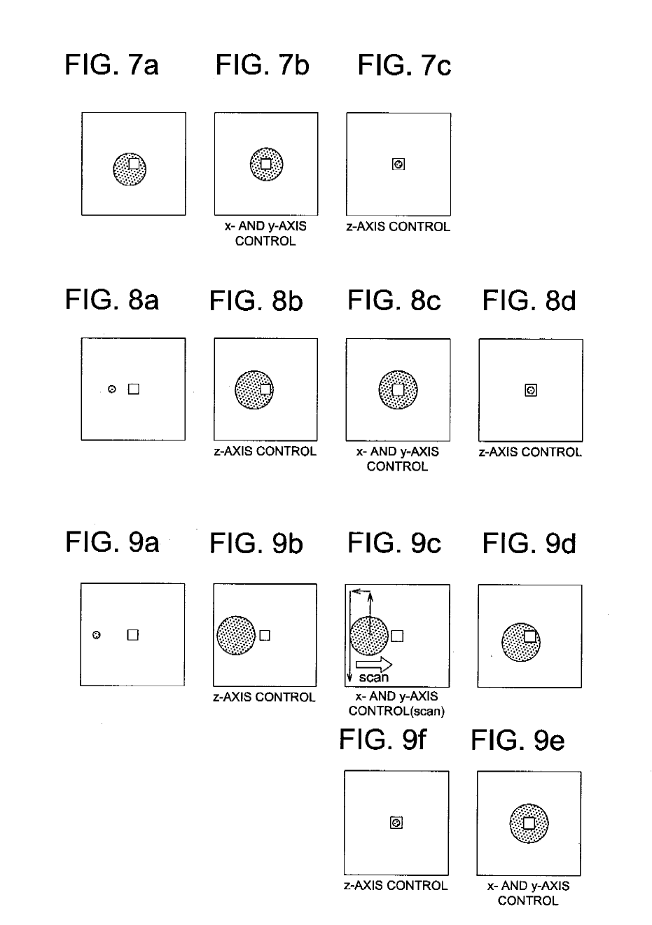

FIGS. 7a, 7b and 7c are explanatory diagrams showing an example of the method for aligning an optical axis of a laser module according to an embodiment of the present invention. In the first place, the intensity of light emitted from the waveguide is measured using the photodiode PD arranged on the light output side of the optical waveguide device SHG. If the intensity of this emerging light is greater than a predetermined reference value, the waveguide is estimated to be present within the range of the light spot, as shown in FIG. 7a.

The position of the focusing spot formed by light converging optical system is aligned in the x-axis and y-axis directions by the x-axis and y-axis fine alignment control (e.g., wobbling mode) using the actuator mechanism containing the actuators M1 and M2. Then, the center of the focusing spot and the waveguide are aligned so that the output of the photodiode PD is maximized (FIG. 7b).

The focusing spot formed by light converging optical system is then adjusted in the z-axis direction using the actuator mechanism so that the output of the photodiode PD is maximized with the focusing spot being in focused (FIG. 7c).

Thus, the aforementioned procedure ensures easy 3D positioning of the focusing spot with respect to the waveguide in a short time.

FIGS. 8a, 8b, 8c and 8d are explanatory diagrams showing another example of the method for aligning an optical axis of a laser module according to an embodiment of the present invention. Similarly to the above case, the intensity of light emitted from the waveguide is measured using the photodiode PD arranged on the light output side of the optical waveguide device SHG. If the intensity of this emerging light is smaller than a predetermined reference value, the focusing spot is approximately focused accidentally, and the waveguide is estimated to be out of the range of the light spot, as shown in FIG. 8a. Under this condition, the diameter of the light spot is very small, and positioning between the light spot and waveguide is very difficult.

To solve the problem, the focusing spot formed by light converging optical system is adjusted in the z-axis direction using the actuator mechanism including the actuators M1 and M2, and the focusing spot is defocused so that the diameter of the light spot on the incident end face is increased. Then, the waveguide is placed within the range of the light spot, which is the same state as shown in FIG. 7a (FIG. 8b).

Similarly to the case of FIG. 7b, the position of the focusing spot formed by light converging optical system is aligned by the x-axis and y-axis directions by the x-axis and y-axis fine alignment control (e.g., wobbling mode) using the actuator mechanism. Then, the center of the light spot and waveguide are aligned so that the output of the photodiode PD is maximized (FIG. 8c).

Similarly to the case of FIG. 7c, the focusing spot formed by light converging optical system is adjusted in the z-axis direction using the actuator mechanism. Then, the focusing spot is set in focus so that the output of the photodiode PD is maximized (FIG. 8d).

Thus, the aforementioned procedure ensures easy 3D positioning of the focusing spot with respect to the waveguide in a short time.

FIGS. 9a, 9b, 9c, 9d, 9e and 9f are explanatory diagrams showing still another example of the method for aligning an optical axis of a laser module in an embodiment of the present invention. Similarly to the above cases, the intensity of light emitted from the waveguide is measured using the photodiode PD arranged on the light output side of the optical waveguide device SHG. If the intensity of this emerging light is smaller than a predetermined reference value, the focusing spot is approximately focused accidentally, and the waveguide is estimated to be out of the range of the light spot, as shown in FIG. 9a. Under this condition, the diameter of the light spot is very small, and positioning between the light spot and waveguide is very difficult.

To solve the problem, similarly to the case of FIG. 8b, the focusing spot formed by light converging optical system is adjusted in the z-axis direction using the actuator mechanism including the actuators M1 and M2, and the focusing spot is defocused so that the diameter of the light spot on the incident end face will be increased (FIG. 9b).

However, even if the diameter of the light spot has been increased by setting the displacement of the z-axis adjustment up to its limit, the waveguide might be out of the range of the light spot in some cases. In this case, the intensity of the emerging light remains at a value equal to or less than a predetermined reference value.

In this case, the system goes to the coarse alignment control (e.g., scan mode) with a large light spot. As shown in FIG. 9c, the focusing spot formed by light converging optical system is scanned in the x-axis and y-axis directions using the actuator mechanism to find out the position wherein the intensity of the emerging light from the waveguide is greater than a predetermined reference value. This allows the waveguide to be placed within the range of the light spot, and the situation is in the same state as shown in FIG. 7a (FIG. 9d).

In this case, the amount of defocusing at the time of x-axis and y-scanning can be set at the position apart by a predetermined distance from the upper or lower limit of the z-axis alignment. This is stored in a memory of the control apparatus of the actuator mechanism. In the piezoelectric actuator such as the SIDM, the aforementioned travel distance can be converted into the number of drive pulses.

Similarly to the case of FIG. 7b, the position of the focusing spot formed by light converging optical system is aligned in the x-axis and y-axis directions by the x-axis and y-axis fine alignment control (e.g., wobbling mode) using the actuator mechanism. Then, the center of the light spot and waveguide are aligned so that the output of the photodiode PD is maximized (FIG. 9e).

Similarly to the case of FIG. 7c, the focusing spot formed by light converging optical system position is adjusted in the z-axis direction using the actuator mechanism. Then, the focusing spot is focused so that the output of the photodiode PD is maximized (FIG. 9f).

Thus, the aforementioned procedure ensures easy 3D positioning of the focusing spot with respect to the waveguide in a short time.

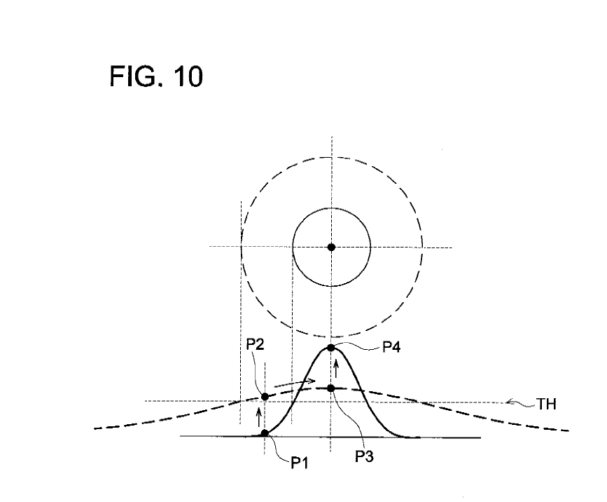

FIG. 10 is a chart showing the power distribution in the state of focused and defocused focusing spot. The power distribution of the laser spot indicates the Gaussian distribution, and suggests that, when the focusing spot is defocused (indicated by a broken line), the peak is lower than when it is focused (indicated by a solid line), and the radius crossing the reference value TH is greater.

The following describes the method of optical axis alignment illustrated in FIGS. 8a, 8b, 8c and 8d: For ease of explanation, the waveguide is assumed to make a relative displacement with respect to the focusing spot used as a fixed reference.

As shown in FIG. 8a, for example, when the focusing spot is focused, the misalignment and the intensity of the emerging light coming from the waveguide correspond to point P1 with the intensity being below the reference value TH.

In the conventional two-axis control, the system proceeds to the coarse alignment control (e.g., scan mode) under this condition. However, the diameter of the light spot is very small under this condition, and hence, positioning between the light spot and waveguide is very difficult.

By contrast, when the three-axis control of the present invention is employed, the focusing spot position is adjusted in the z-axis direction using the actuator mechanism, as shown in FIG. 8b, and the focusing spot is defocused so that the diameter of the light spot is increased. In this case, the system goes from point P1 to point P2, and so that the intensity exceeds the reference value TH. This allows the system to proceed to the x-axis and y-axis fine alignment control (e.g., wobbling mode).

The position of the focusing spot is then adjusted in the x-axis and y-axis directions using the actuator mechanism, and the center of the light spot and waveguide are aligned so that the intensity of the emerging light is maximized (FIG. 8c). In this case, the system proceeds from point P2 to point P3 in FIG. 10.

Then, the focusing spot position is adjusted in the z-axis direction using the actuator mechanism, and the focusing spot is focused so that the intensity of the emerging light is maximized (FIG. 8d). In this case, the system proceeds from point P3 to point P4 in FIG. 10.

Further, after the focusing spot is once focused, the position of the focusing spot may be adjusted in the x-axis and y-axis directions again so that the intensity of the emerging light is maximized. More accurate alignment can be achieved because the peak of the light spot is steeper.

According to the embodiment of the present invention, when an actuator mechanism for 3D positioning is installed, the focusing spot formed by light converging optical system located between the laser device and optical waveguide device can be subjected to focusing and defocusing control in the optical axis direction, in addition to alignment control in the in-plane area perpendicular to the optical axis direction.

For example, when the focusing spot formed by light converging optical system is approximately focused accidentally, and the diameter of the light spot on the incident end face of the optical waveguide device is very small, positioning between the light spot and waveguide is considerably difficult in that situation. To solve this problem, the focusing spot formed by light converging optical system is temporarily defocused by adjustment of the converging optical system in the optical axis direction, and the diameter of the light spot on the incident end face is made larger. Under this condition, alignment is conducted in the in-plane area perpendicular to the optical axis direction, whereby positioning between the light spot and waveguide is greatly facilitated. Upon completion of alignment, focusing control is provided in the optical axis direction, whereby easy 3D positioning of the focusing spot can be achieved in a shorter period of time.

The present invention ensures easy optical axis alignment with a very small waveguide in a short period of time, and hence, provides enormous industrial advantages.

What is claimed is:

1. A laser module, comprising:
a laser device;
an optical waveguide device having a waveguide;
a light converging optical system for converging a light beam from the laser device to form a focusing spot at which a diameter of the light beam is the smallest, and leading the converged light beam into the waveguide of the optical waveguide device; and
an actuator mechanism for three dimensionally positioning the focusing spot.

2. The laser module of claim 1, comprising:
a photodetector for measuring an intensity of a light beam emerging from the optical waveguide device; and
a controller for controlling the actuator mechanism based on an output of the photodetector.

3. The laser module of claim 1, wherein the light converging optical system includes from an object side:
a first lens unit; and
a second lens unit,
wherein the actuator mechanism is adapted to position the second lens unit at least in an optical axis direction thereof.

4. The laser module of claim 3, wherein the first lens unit is a collimator lens.

5. The laser module of claim 3, wherein the actuator mechanism is adapted to position the second lens unit in the optical axis direction, in a first direction perpendicular to the optical axis direction, and in a second direction perpendicular to the optical axis direction and the first direction.

6. The laser module of claim 3, wherein the actuator mechanism includes:
a first actuator section for positioning the first lens unit in a first direction perpendicular to the optical axis direction; and
a second actuator section for positioning the second lens unit in the optical axis direction and in a second direction perpendicular to the optical axis direction and the first direction.

7. The laser module of claim 3, wherein the actuator mechanism includes:
a first actuator section for positioning the first lens unit in a first direction perpendicular to the optical axis direction and in a second direction perpendicular to the optical axis direction and the first direction; and
a second actuator section for positioning the second lens unit in the optical axis direction.

8. The laser module of claim 6, wherein the first direction is a horizontal direction, and the second direction is a vertical direction.

9. The laser module of claim 6, wherein the first direction is a vertical direction, and the second direction is a horizontal direction.

10. The laser module of claim 1, wherein the actuator mechanism includes a smooth impact drive mechanism.

11. A method for adjusting an optical axis of a laser module having a laser device; an optical waveguide device having a waveguide; a light converging optical system for converging a light beam from the laser device to form a focusing spot at which a diameter of the light beam is the smallest, and leading the converged light beam into the waveguide of the optical waveguide device; and an actuator mechanism for three dimensionally positioning the focusing spot by driving the light converging optical system, the method comprising the steps of:
measuring intensity of an emerging light beam from the waveguide by a photosensor provided on a light emitting side of the optical waveguide device;
adjusting, when the intensity of the emerging light beam is greater than a predetermined reference value, a position of the focusing spot by using the actuator mechanism in a first direction perpendicular to an optical axis direction and in a second direction perpendicular to the optical axis direction and the first direction so that the intensity of the emerging light beam is at a peak value thereof; and
focusing, after the step of adjusting, the converging optical system by adjusting the position of the focusing spot by using the actuator mechanism in an optical axis direction so that the intensity of the emerging light beam is at a peak value thereof after the step of adjusting.

12. The method of claim 11, wherein in the step of adjusting, the actuator mechanism scans the position of the focusing spot to align the focusing spot with the optical waveguide device.

13. The method of claim 11, comprising, after the step of focusing, the step of:
adjusting the position of the focusing spot by using the actuator mechanism in a first direction perpendicular to an optical axis direction and in a second direction perpendicular to the optical axis direction and the first direction so that the intensity of the emerging light beam is at a peak value thereof.

14. A method for adjusting an optical axis of a laser module having a laser device; an optical waveguide device having a waveguide; a light converging optical system for converging a light beam from the laser device to form a focusing spot at which a diameter of the light beam is the smallest, and leading the converged light beam into the waveguide of the optical waveguide device; and an actuator mechanism for three dimensionally positioning the focusing spot by driving the light converging optical system, the method comprising the steps of:
measuring intensity of an emerging light beam from the waveguide by a photosensor provided on a light emitting side of the optical waveguide device;
defocusing, when the intensity of the emerging light beam is less than or equal to a predetermined reference value, the converging optical system by adjusting a position of the focusing spot in the optical axis direction by using the actuator mechanism;
adjusting, after the step of defocusing, the position of the focusing spot by using the actuator mechanism in a first direction perpendicular to an optical axis direction and in a second direction perpendicular to the optical axis direction and the first direction so that the intensity of the emerging light beam is at a peak value thereof; and
focusing, after the step of adjusting, the converging optical system by adjusting the position of the focusing spot by using the actuator mechanism in the optical axis direction so that the intensity of the emerging light beam is at a peak value thereof.

15. The method of claim 14, wherein in the step of defocusing, the actuator mechanism repeatedly moves the position of the focusing spot in the optical axis direction by a predetermined distance each time.

16. The method of claim 14, comprising, after the step of defocusing, the step of:
scanning, when the intensity the emerging light beam is less than or equal to a predetermined value, the position of the focusing spot in a direction perpendicular to the optical axis direction.
